(19) United States
(12) Patent Application Publication
(10) Pub. No.: US 2025/0344638 A1
(43) Pub. Date: Nov. 13, 2025

(54) METHOD FOR OPERATING A FRONT ATTACHMENT ARRANGED ON A PICK-UP DEVICE OF A COMBINE HARVESTER AND SELF-PROPELLED COMBINE HARVESTER

(71) Applicant: CLAAS Selbstfahrende Erntemaschinen GmbH, Harsewinkel (DE)

(72) Inventors: Christian Füchtling, Rinkerode (DE); Andreas Wielenberg, Herford (DE); Thomas Hinz, Harsewinkel (DE); Udo Beschorn, Harsewinkel (DE)

(73) Assignee: CLAAS Selbstfahrende Erntemaschinen GmbH, Harsewinkel (DE)

(21) Appl. No.: 19/202,297

(22) Filed: May 8, 2025

(30) Foreign Application Priority Data
May 8, 2024 (DE) 10 2024 112 871.2

(51) Int. Cl. A01D 41/127; A01D 41/02; A01D 41/14

(52) U.S. Cl. CPC A01D 41/1274; A01D 41/02; A01D 41/145

(57) ABSTRACT

A method for operating an attachment of a self-propelled combine harvester and a combine harvester. The attachment is arranged on a pick-up device, height-adjustable by actuators, and has a center segment and at least two side segments, each having a position-variable support element arranged on the side segments and acted upon by a pressure-controlled support force. In a first operating mode, a control device performs transverse control based on distance between the ground and the attachment, with the distance being determined by signals generated by distance sensors on an underside of the attachment and contacting the ground the attachment and/or the given side segments depending on the signals. In a second operating mode, the control device performs transverse control based on signals generated by sensor units assigned to the support elements for determining the distance of the attachment and/or the respective side segments from the ground.

### CROSS REFERENCE TO RELATED APPLICATIONS

This application claims priority under 35 U.S.C. § 119 to German Patent Application No. DE 10 2024 112 871.2 filed May 8, 2024, the entire disclosure of which is hereby incorporated by reference herein. This application is related to U.S. application Ser. No. ______ (attorney ref. no. 15191-25004A (P05824/8), which is incorporated by reference herein in its entirety.

### TECHNICAL FIELD

The present invention relates to a method for operating a front attachment that is arranged or positioned on a pick-up device of a self-propelled combine harvester and that is adjustable in height by actuators, and to a self-propelled combine harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

US Patent Application Publication No. 2023/0105797 A1, incorporated by reference herein in its entirety, discloses a method for operating an attachment arranged or positioned on a pick-up device, adjustable in height by actuators, of a self-propelled combine harvester and a self-propelled combine harvester. Specifically, a method is disclosed for controlling the cutting height of the attachment which determines the distance of the front attachment from the ground by evaluating sensor signals which are determined from a plurality of sensing bands contacting the ground that are arranged or positioned on the individual segments of the attachment. On this attachment, three separate controls are designed for ground guidance by controlling the cutting height. Height control, transverse control of the entire front attachment and transverse control of the individual side segments relative to the center segment are performed. For this purpose, the distance between the attachment and the ground may be measured across the width at several points by the sensing bands.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic partial view of a combine harvester with an attachment arranged or positioned thereon.

FIG. 2 illustrates a schematic partial view of an attachment designed as a draper.

FIG. 3 illustrates a highly simplified representation of the front attachment according to FIG. 2.

### DETAILED DESCRIPTION

As discussed in the background, US Patent Application Publication No. 2023/0105797 A 1 discloses a method for operating a front attachment arranged or positioned on a pick-up device. As discussed above, the distance between the attachment and the ground is measured across the width at several points by the sensing bands. The measuring range of the distance determination may be limited by the sensing bands contacting the ground. This may be accompanied by a restriction of the working range of the cutting height control since this is limited to the measuring range of the sensing bands. This may be a disadvantage in that if the crop is cut above the measuring range of the sensing bands, as may be the case with rapeseed, for example, the sensor signals from the sensing bands may not be available for the transverse control of the attachment or the side segments. This may mean that either contact-free working distance sensors are required that reliably detect the distance to the ground at the set cutting height, or this task is assigned to the operator of the combine harvester, which may quickly become overwhelming to him/her.

As such, in one or some embodiments, a method and apparatus are disclosed for operating an attachment of the aforementioned type arranged or positioned on a pick-up device, height-adjustable by actuators, of a self-propelled combine harvester in such a way that transverse control of the attachment above the measuring range of the distance sensors contacting the ground is made possible. In particular, additional sensors, for example contact-free working sensors, for determining the distance on the attachment may be dispensed with.

In one or some embodiments, a method is disclosed for operating an attachment arranged or positioned on a pick-up device of a self-propelled combine harvester and adjustable in height by actuators. The pick-up device serves to position the attachment on the combine harvester and to convey the harvested material. For this purpose, a conveyor device, for example an inclined conveyor, is arranged or positioned in the pick-up device. The attachment comprises a center segment (alternatively termed a middle segment) and at least two side segments (with the side segments flanking the center segment), each with at least one variable-position support element arranged or positioned on the side segments and subjected to a pressure-controlled support force. Various operated modes, such as multiple operating modes, may be used. For example, in a first operating mode, one or more distance sensors (arranged or positioned on the underside of the attachment and contacting the ground) may generate one or more sensor signals indicative of a distance between the ground and the attachment. A control device (interchangeably termed as a controller or control unit) may receive the one or more sensor signals for evaluation in order to, in the first operating mode, actuate a transverse control of the attachment device and/or the one or more side segments depending on the one or more signals (e.g., a transverse position angle of the attachment device is set by pivoting about a virtual pendulum axis of the pick-up device). In one or some embodiments, in a second operating mode, in which only the support elements are in contact with the ground, the control device may perform the transverse control of the attachment device and/or the given or respective side segments depending on different signals than used for evaluation by the control device in the first operating mode, specifically one or more signals generated by sensor unit(s) assigned to the support elements for determining the distance of the attachment device and/or the given or respective side segments from the ground. In this regard, the control device may perform the transverse control of the attachment device and/or the one or more side segments differently in different operating modes by evaluating different determined distances.

In one or some embodiments, the transverse control of the attachment and/or the given side segments may be performed using the sensor signals generated by the sensor units that are assigned to the support elements to which an adjustable support force is applied. The transverse control of the attachment and/or the given side segments in the second operating mode may thus be performed indirectly (e.g., using signals for determining the distance), which may be available independently of the distance sensors in contact with the ground.

In particular, the attachment may be operated in high cut in the second operating mode. In high cut, the distance to the ground may be determined by a height of the pick-up device set by the actuators. Moreover, the distance sensors may not have any ground contact.

In one or some embodiments, the number of additional sensors that are required to detect the distance to the ground in the second operating mode may be significantly reduced by the disclosed method.

In particular, a vertical deflection of the given or respective support element may be detected by the sensor units. In one or some embodiments, the support elements may be actuated passively or actively. Passive support elements may be designed with a hydro-pneumatic suspension. Active support elements may be designed with actuators, such as hydraulic cylinders, controllable by pressure control which may apply a support force to the support elements, with which the support elements may be supported on the ground. By changing the pressurization of the actuators, the support force with which the support elements are supported against the ground may be adjusted, which may change or control the vertical deflection of the support elements.

In the second operating mode for transverse control of the attachment, the deflection (such as the vertical deflection) of the support elements may be controlled depending on a deflection difference (such as the vertical deflection difference) in that the pressure-controlled actuators on the support elements may be controlled until the deflection difference is reduced, such as reduced to zero basically zero.

Alternatively, in the second operating mode for transverse control of the attachment, it may be controlled depending on a deflection difference of the support elements in that at least one actuator on the pick-up device is controlled, by means of which the attachment device may be pivoted about its virtual pendulum axis until the deflection difference is reduced, such as reduced to zero or basically zero. The deflection difference of the support elements may be determined from the difference in the detected deflection of the given support element.

If, for transverse control of the attachment, the deflection of the support elements is controlled depending on the deflection difference in that the pressure-controlled actuators of the support elements are actuated, the at least one actuator on the pick-up device may be operated in a floating position so that the support elements are actively influenced only by activating the actuators on the support elements using the pressure control until the deflection difference of the support elements is reduced, such as reduced to zero or basically zero.

In one or some embodiments, a scaling factor may be used when determining the deflection difference. Using the scaling factor, a systematic deviation may be taken into account that arises when determining the deflection difference. The scaling factor for the deflection difference may be determined on the basis of the technical and/or geometric nature of the support elements and/or experimentally.

In one or some embodiments, an angle of inclination of the pick-up device may be used for height control of the attachment. The angle of inclination may be determined by at least one angle sensor and/or by detecting the displacement of the actuators on the pick-up device using at least one displacement sensor.

In one or some embodiments, the side segments may each be pivotably connected to the center segment by a frame joint about a pivot axis oriented in the driving direction, wherein the given side segment may be pivoted relative to the center segment about the pivot axis for transverse control using at least one actuator each, which may be controlled independently of one another by the control device. This may allow the side segments to be controlled or regulated independently of the height and/or transverse guidance of the attachment. Each side segment may react to changes in the ground contour, wherein the positioning of the side segments may be performed independently of the height and transverse guidance of the attachment as a whole. This may enable optimized adaptation to the existing ground contour.

In particular, in the second operating mode, the position of the given or respective side segment relative to the center segment may be calculated depending on a distance difference between the given or respective side segment and the ground, wherein the distance difference may be determined from measured variables independent of the signals from the distance sensors. The distance difference of a side segment may be determined in relation to the arrangement on the center segment from the difference between the proximal and distal distance of the side segment to the ground. In particular, the position of the given side segment relative to the center segment may be determined by interpolation in the area of the given frame joint. In the area of the frame joint, the distance to the ground may be determined from the angle of inclination of the pick-up device and the transverse position angle of the center segment.

In the second operating mode, the transverse control of the given side segment may be performed depending on any one, any combination, or all of: the angle of inclination of the pick-up device; a transverse position angle of the center segment; an inclination of the given side segment to the center segment as independent measured variables; or the deflection of the support element assigned to the given side segment. This may allow the working range of the cutting height control to be extended beyond the measuring range of the distance sensors contacting the ground. As a result, a parallel position of the given side segment to the ground may be achieved even if the signals from the distance sensors contacting the ground are not available in the second operating mode. This may be the case, in particular, when cutting high.

In particular, in the second operating mode, the transverse control of a rigid or rigidly operable attachment may also use any one, any combination, or all of the angle of inclination of the pick-up device, transverse position angle of the center segment, or the deflection of the support element assigned to the given side segment in order to extend the working range of the cutting height control beyond the measuring range of the distance sensors contacting the ground.

Furthermore, when determining the distance difference, at least one scaling factor may be used for the given independent measured variable. Using the specific scaling factors for each measured variable, a systematic deviation may be taken into account that arises when determining the distance difference.

A further advantage may result from the fact that the scaling factors may be weighted differently, whereby the response behavior of the attachment and actuators may be influenced during their control and/or the measuring sensitivity.

In one or some embodiments, pivotable sensing bands may be used as distance sensors contacting the ground, the actual pivot position (interchangeably termed actual swivel position) of which may be detected by sensors assigned thereto, wherein the detected actual pivot position may be compared in the second operating mode with a threshold value stored or storable in the control device.

In particular, in the second operating mode, the signals from the sensing bands may be taken into account in the transverse control of the attachment and/or the given side segments if the value falls below the threshold value. In the second operating mode, the ground guidance of the attachment may have a lower precision due to the use of substitute variables instead of the signals of the distance sensors designed as sensing bands.

Over the course of controlling, the distance between the attachment and the ground in the area of at least one sensing band may become so small that it may come into contact with the ground. In this case, the signals of the at least one sensing band may not be taken into account in the second operating mode, provided that the actual pivot position does not fall below the threshold value. Only when the actual pivot position of at least one sensing band is less than the threshold value due to the decreasing distance to the ground may the signal from the sensing band be taken into account in the corresponding transverse control of the second operating mode in order to prevent a collision of the attachment and/or a side segment with the ground.

The object posed at the outset may further be accomplished by a combine harvester. In particular, a self-propelled combine harvester with a height-adjustable pick-up device is disclosed, on which an attachment is arranged or positioned which comprises a center segment and at least two side segments, wherein at least one position-adjustable support element acted upon by a pressure-controlled support force is arranged or positioned on each of the side segments, wherein distance sensors contacting the ground are arranged or positioned on the underside of the attachment in order to determine a distance between the ground and the attachment, wherein a control device is configured to evaluate the signals provided by the distance sensors in a first operating mode in order to actuate a transverse control of the attachment and/or the given side segments in the first operating mode depending on the signals, wherein the control device is configured to adjust a transverse position angle of the attachment by pivoting about a virtual pendulum axis of the pick-up device. For this purpose, in a second operating mode, in which only the support elements are in contact with the ground, transverse control of the attachment device and/or the given side segments may be performed depending on signals that are provided by sensor units assigned to the support elements for determining a distance of the attachment device and/or the given side segments from the ground. Reference may be made to the discussion herein regarding the method, which may be performed by the combine harvester.

In one or some embodiments, the control device may be configured to control the transverse control of the attachment in the second operating mode depending on a deflection difference of the support elements in that pressure-controlled actuators assigned to the support elements are actuated until the deflection difference of the support elements is reduced, such as reduced to zero or basically zero.

In one or some embodiments, the side segments may each be pivotably connected to the center segment by a frame joint about a pivot axis oriented in the driving direction, wherein the given side segment may be pivotable relative to the center segment about the pivot axis using an actuator actuated by the control device for transverse control, wherein the control device is configured to determine the position of the given or respective side segment relative to the center segment in the second operating mode, wherein the control device is configured to determine a distance difference of the given side segment to the ground from measured variables independent of the signals of the distance sensors.

Also, in one or some embodiments, the control device may be configured to perform the transverse control of the given side segment in the second operating mode depending on any one, any combination, or all of: the angle of inclination of the pick-up device; a transverse position angle of the center segment; an inclination of the given side segment to the center segment; or the deflection of the support element assigned to the given side segment as measured variables independent of the signals of the distance sensors.

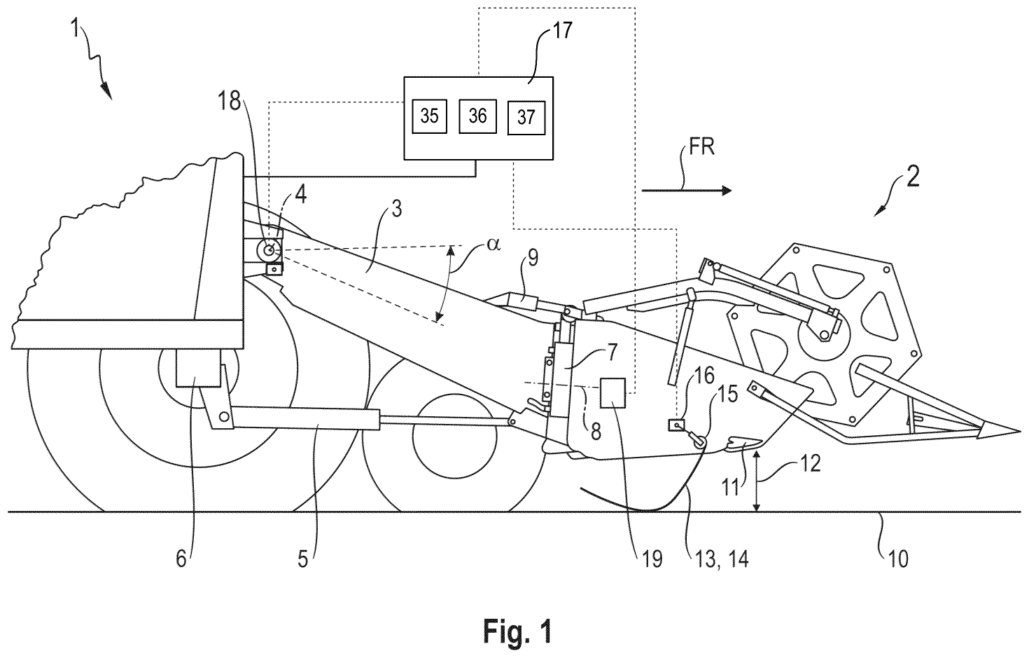

Referring to the figures, FIG. 1 shows a schematic partial view of a combine harvester 1 with an attachment 2 arranged or positioned thereon. Example combine harvesters are disclosed in US Patent Application Publication No. 2019/0343044 A 1; US Patent Application Publication No. 2021/0360861 A1; US Patent Application Publication No. 2023/0397533 A1; US Patent Application Publication No. 2024/0196796 A1; or US Patent Application Publication No. 2025/0048965 A 1, each of which is incorporated by reference herein in its entirety.

The attachment 2 is arranged or positioned on a pick-up device 3. The pick-up device 3 may be pivoted in the vertical direction about a pivot axis 4 oriented transversely to the driving direction FR. The pick-up device 3 is pivotable about the pivot axis 4 extending transversely to the driving direction FR by at least one actuator 5 which is articulated at one end to a bracket 6 of the combine harvester 1 and at its other end to the pick-up device 3. The at least one actuator 5 may be designed as a hydraulic cylinder.

Using at least one actuator 7, a lateral adjustment of the attachment 2 to the current ground level may be controlled, wherein in one or some embodiments, the at least one actuator 7, designed as a lifting cylinder, may pivot the attachment 2 in a known manner about a virtual pendulum axis 8 pointing in the driving direction FR. Using an angle sensor 19, the angle by which the attachment 2 is pivoted about the pendulum axis 8 may be determined. A hydraulic cylinder 9 arranged or positioned on the top of the pick-up device 3 may make it possible to set a cutting angle that is enclosed by the attachment 2 and the ground 10.

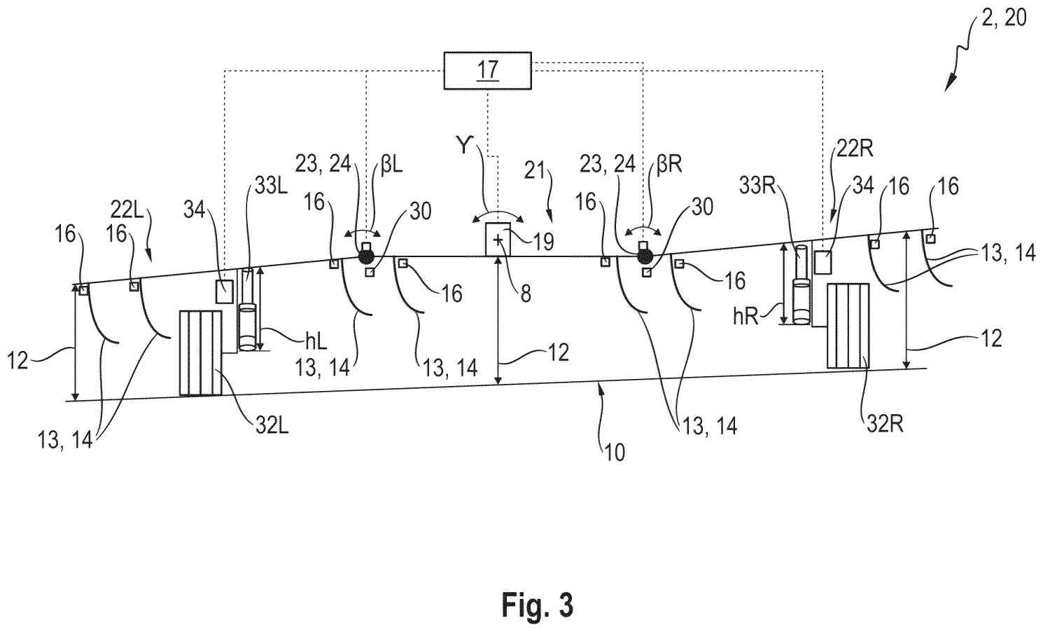

In one or some embodiments, the attachment 2 may comprise a cutter bar 11, which may be guided at or configured to an adjustable vertical distance 12 from the ground 10. The vertical distance 12 may be set by the actuators 5 on the pick-up device 3. To monitor the compliance with the distance 12 to the ground 10 in a first operating mode, a plurality of distance sensors 13 contacting the ground 10 are arranged or positioned on the underside of the attachment 2. In the depicted embodiment, the distance sensors 13 are designed as sensing bands 14, as shown in FIG. 3. The sensing bands 14 may each be pivotable about an axis 15 extending transversely to the driving travel FR. The swivel movement or pivot movement of the given sensing band 14 may be determined using sensor data (e.g., signals) generated by sensor 16, which may be coupled to the given axis 15. The sensors 16 may comprise potentiometers. A control device 17 is configured to control the combine harvester 1 and its working units, which may include, inter alia, the attachment 2 and the pick-up device 3.

In one or some embodiments, the control device 17 may include at least one processor 35, at least one memory 36, and at least one communication interface 37. The at least one processor 35 and at least one memory 36 may be in communication (e.g., wired and/or wirelessly) with one another. In one or some embodiments, the processor 35 may comprise a microprocessor, controller, PLA, or the like. Similarly, the memory 36 may comprise any type of storage device (e.g., any type of memory). Though the processor 35 and the memory 36 are depicted as separate elements, they may be part of a single machine, which includes a microprocessor (or other type of controller) and a memory. Alternatively, the processor 35 may rely on the memory 36 for all of its memory needs. Still alternatively, the processor 35 may rely on a database for some or all of its memory needs. The memory 36 may comprise a tangible computer-readable medium that include software that, when executed by the processor 35 is configured to perform any one, any combination, or all of the functionality described herein, such as automatically receiving signals from one or more sensors, automatically controlling height adjustment (e.g., controlling actuators 5 for height adjustment of the center segment 21 and/or one or both of the two side segments 22L, 22R). Further, the communication interface 37 may be configured to communicate (e.g., wired and/or wirelessly) with one or more electronic devices. As one example, the communication interface 37 may be used to communicate with the sensors and/or the actuators 5.

The processor 35 and the memory 36 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

An angle of inclination may be determined by sensor data generated by at least one angle sensor 18 and/or by detecting the displacement of the actuators 5 on the pick-up device 3 using at least one displacement sensor. The signals from the at least one angle sensor 18 may be automatically transmitted to the control device 17 for evaluation or analysis. In one or some embodiments, the actuators 5 may be automatically actuated by the control device 17.

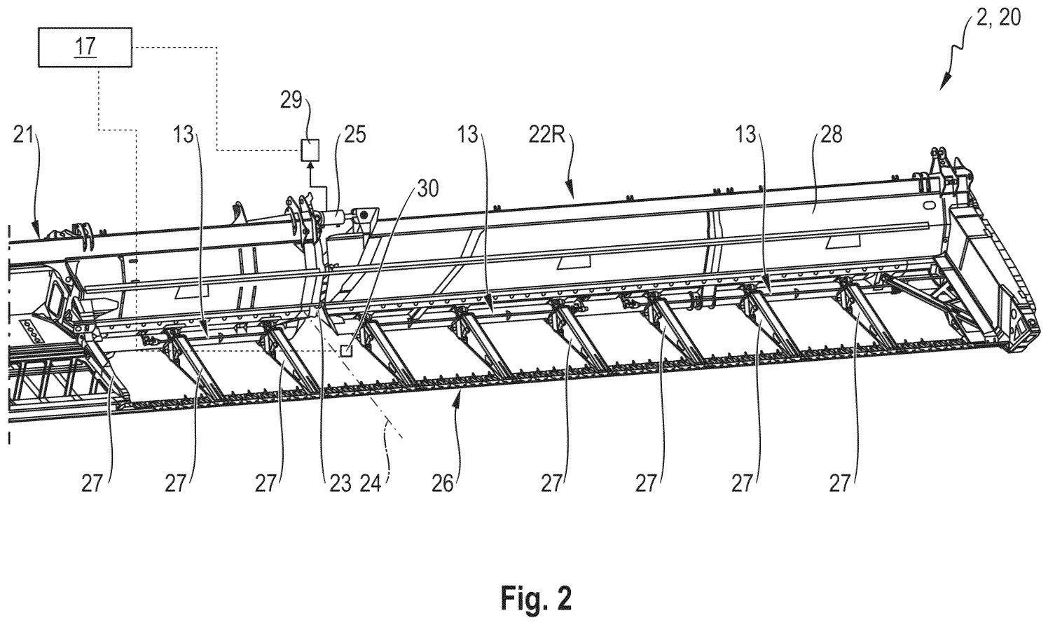

FIG. 2 is a schematic showing a partial view of an attachment 2 designed as a draper 20. The design of the attachment 2 designed as a draper 20 is mirror-symmetrical, so that the following explanations correspondingly apply to the half of the draper 20 that is not shown.

The draper 20 may comprise a center segment 21, half of which is shown in FIG. 2, and at least two side segments 22L, 22R. Of the side segments 22L, 22R, only the right-hand side segment 22R is shown in FIG. 2. The draper 20 is arranged or positioned on the pick-up device 3 in the area of the center segment 21, as previously described. Conveyor belts (not shown) may be configured to convey the picked-up harvested material, which may convey the harvest material from the side segments 22L, 22R sideways to the center segment 21 in a known manner. The given side segments 22L, 22R may each be pivotably connected to the center segment 21 by a frame joint 23 about a pivot axis 24 oriented parallel to the driving direction FR and running substantially horizontally. The given or respective side segments 22L, 22R may be pivoted in a vertical direction relative to the center segment 21 about the pivot axis 24 using an actuator 25. With respect to the center segment 21, the side segments 22L, 22R may be transferred into a position in which the outer end of the given side segment 22L, 22R is located in a plane above and/or below the center segment 21.

A pressure sensor 29 may be assigned to the actuator 25, which may comprise a hydraulic cylinder, through which the pressurization of the actuator 25 may be detected in order to actuate it by the control device 17. The given pivot axis 24 may be assigned a sensor device 30, such as a potentiometer, whose sensor data may be used to determine the position of the given side segment 22L, 22R relative to the center segment 21. The respective sensor device 30 may be configured to generate sensor data in order to determine an inclination BR, BL, caused by the pivoting about the pivot axis 24, of the given side segment 22L, 22R relative to the center segment 21. The sensor data (e.g., the signals) from the sensor devices 30 may be automatically transmitted to the control device 17 for evaluation.

A flexible cutter bar 26 may be arranged or positioned in the front area of the attachment 2, which may be designed as a draper 20, and may extend substantially over the entire width of the draper 20. A plurality of support arms 27, which may be distributed over the width of the draper 20 and may be arranged or positioned with one end pivotable about an axis extending transversely to the driving direction FR on the frame 28 of the draper 20, which may be subdivided or segmented into the central segment 21 and the at least two side segments 22L, 22R, may support the cutter bar 26 at its free end. Due to the individual pivotability of the support arms 27, the flexible cutter bar 26 may execute a compensating movement in a vertical direction in order to respond to a change in the ground contour, which may be absorbed by the support arms 27 guided over the ground. In so doing, the cutter bar 26 may undergo a substantially undulating deflection.

The illustration in FIG. 3 shows a schematic and highly simplified representation of the segmented attachment 2 designed as a draper 20 according to FIG. 2 in a second operating position. The simplified illustration shows the arrangement of the distance sensors 13, which may comprise sensing bands 14, on the underside of the attachment 2.

At least one position-adjustable support element 32R, 32L may be arranged or positioned on each of the side segments 22R, 22L. The given position-adjustable support element 32R, 32L may be pivotable about an axis extending parallel to the attachment 2. In one or some embodiments, the given support element 32R, 32L is designed as a support wheel.

The support elements 32R, 32L may be actuated passively or actively in order to adjust their height in the vertical direction by retraction or extension. Passive support elements 32R, 32L may be designed with a hydro-pneumatic suspension. In one or some embodiments, the active support elements 32R, 32L have pressure-controlled actuators 33R, 33L associated therewith. The actuators 33R, 33L may be designed as actuatable linear actuators, such as hydraulic cylinders, in order to apply a pressure-controlled support force to the support elements 32R, 32L. By changing the pressurization of the actuators 33R, 33L, the support force acting on the support elements 32R, 32L may be changed, which may change their vertical deflection hR, hL and thus the distance 12 between the attachment 2 or draper 20 and the ground 10. US Patent Application Publication No. 2023/0076926 A 1, incorporated by reference herein in its entirety, discloses a pressure control for the actuators 33R, 33L of the active support elements 32R, 32L.

In the illustrated second operating position, only the support elements 32R, 32L are in contact with the ground 10. In this second operating mode, in which only the support elements 32R, 32L are in contact with the ground 10, transverse control of the attachment 2 and/or the given side segments 22R, 22L may be performed by the control device 17 depending on signals that are generated by sensor units 34 assigned to the support elements 32R, 32L for determining the distance 12 of the attachment and/or the given side segments 22R, 22L from the ground 10.

In one or some embodiments, the sensor units 34 assigned to the support elements 32R, 32L for determining the deflection hR, hL relative to the ground 10 may, for example, be designed as pressure and/or position sensors. The signals from the sensor units 34 may be automatically transmitted to the control device 17 for evaluation.

As may be seen from the representation in FIG. 3, the distances 12 of the side segments 22R, 22L to the ground 10 may differ from one another if the side segments 22R, 22L are adjusted independently of one another in their inclination BR, BL to the center segment 21 following the ground contour.

The inclination of the attachment 2 or the center segment 21 of the draper 20 relative to the combine harvester 1 may be referred to as the transverse position angle y. The attachment 2 or the center segment 21 may be pivoted about the virtual pendulum axis 8, which may adjust the transverse position angle y (e.g., the inclination relative to the combine harvester 1). The transverse position angle y may be detected by at least one angle sensor 18. The signals from the angle sensor 18 may be transmitted to the control device 17 for evaluation.

In the second operating mode, the control device 17 may perform transverse control over the entire width of the attachment 2 by means of measured variables independent of the signals from the distance sensors 13 contacting the ground 10, in this case the deflection hR, hL of the support elements 32R, 32L.

For this purpose, in the second operating mode for transverse control over the entire width of the attachment 2, the deflection hR, hL of the support elements 32R, 32L may be controlled by the control device 17 depending on a deflection difference Ah by actuating the actuators 5 on the pick-up device 3 until the deflection difference Ah is reduced, such as reduced to zero or basically zero (e.g., within a predetermined tolerance, such as a tolerance determined in a percentage and/or determined in terms of a distance).

The deflection difference Δh may be determined as follows:

$$Δ h = {k}_{0} ( hR - h L ) .$$

A scaling factor k₀ may be used to scale the deflection hR, hL of the support elements 32R, 32L.

The angle of inclination a of the pick-up device 3 may be used in the first and second operating mode for height control of the attachment 2 or respectively the draper 20.

In the second operating mode, the position of the given side segment 22R, 22L relative to the center segment 21 may be calculated depending on a distance difference ΔhR, ΔhL of the given side segment 22R, 22L to the ground 10. In so doing, the distance difference ΔhR, ΔhL may be determined from measured variables independent of the signals from the distance sensors 13 contacting the ground 10.

For this purpose, in the second operating mode, the transverse control of the given side segment 22R, 22L may be performed by the control device 17 depending on any one, any combination, or all of: the inclination angle a of the pick-up device 3; the transverse position angle γ of the center segment 21; the inclination βR, βL of the given side segment 22R, 22L relative to the center segment 21 as independent measured variables; or the deflection hR, hL of the support element 32R, 32L assigned to the given side segment 22R, 22L.

In particular, the position of the given side segment 22R, 22L relative to the center segment 21 may be determined by interpolation in the area of the given frame joint 23.

The distance difference ΔhR of the side segment 22R and the distance difference ΔhL of the side segment 22L to the ground 10 may be determined for the given side segment 22R, 22L using the aforementioned substitute variables as follows:

$$Δ hL = {k}_{1} * α - {k}_{2} * γ - {k}_{3} * ( β L - β R ) - {k}_{4} * h L$$

$$and$$

$$Δ hR = {k}_{1} * α + {k}_{2} * γ + {k}_{3} * ( β L - β R ) - {k}_{4} * h R .$$

Scaling factors k₁, k₂, k₃, k₄ may be used to scale the substitute variables of the inclination angle α, transverse position angle γ, inclination β and deflection hR, hL of the given support element 32R, 32L used in the second operating mode.

The distance difference ΔhR, ΔhL determined for the given side segment 22R, 22L may be used for individual transverse control of the given side segment 22R, 22L.

As a result, a parallel position of the given side segment 22R, 22L to the ground 10 may be achieved even if the signals of the distance sensors 13 contacting the ground 10 are not available in the second operating mode.

The actual pivot position of the sensing bands 14 may be detected by means of the sensors 16 assigned to the sensing band 14. The detected actual pivot position may be compared with a threshold value stored or storable in the control device 17. In the first operating mode, the transverse position control of the attachment 2 and/or the side segments 22R, 22L may be performed by the control device 17 depending on the actual pivot position.

In the second operating mode, the signals from the sensing bands 14 may only be taken into account in the transverse control of the attachment 2 and/or the given side segments R22, 22L if the value falls below the threshold value.

In the second operating mode, the ground guidance of the attachment 2 may have a lower precision due to the use of the substitute variables instead of the signals of the distance sensors 13 designed as sensing bands 14. Over the course of controlling, the distance 12 between the attachment 2 and the ground 10 in the area of at least one sensing band 14 may become so small that it may come into contact with the ground 10. In this case, the signals of the at least one sensing band 14 are not taken into account, provided that the actual pivot position does not fall below the threshold value. Only when the actual pivot position of at least one sensing band 14 is less than the threshold value due to the decreasing distance 12 to the ground is the signal from the sensing band 14 taken into account in the corresponding control of the second operating mode in order to prevent a collision of the attachment 2 and/or a side segment 22R, 22L with the ground 10.

In the second operating mode, the control device 17 may be configured to perform the transverse control of the given side segment 22R, 22L depending on any one, any combination, or all of the used substitute variables of the inclination angle α, lateral position angle γ, inclination β, or deflection hR, hL of the given support element 32R, 32L, such as all of the used substitute variables of the inclination angle α, lateral position angle γ, inclination β and deflection hR, hL of the given support element 32R, 32L as measured variables independent of the distance sensors 13.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Combine harvester |
| 2 | Front attachment |
| 3 | Pick-up device |
| 4 | Pivot axis |
| 5 | Actuator |
| 6 | Console |
| 7 | Actuator |
| 8 | Pendulum axis |
| 9 | Hydraulic cylinder |
| 10 | Ground |
| 11 | Cutter bar |
| 12 | Distance |
| 13 | Distance sensor |
| 14 | Sensing band |
| 15 | Axis |
| 16 | Sensor |
| 17 | Control device |
| 18 | Angle sensor |
| 19 | Angle sensor |
| 20 | Draper |
| 21 | Center segment |
| 22R | Side segment |
| 22L | Side segment |
| 23 | Frame joint |
| 24 | Pivot axis |
| 25 | Actuator |
| 26 | Cutter bar |
| 27 | Support arm |
| 28 | Frame |
| 29 | Pressure sensor |
| 30 | Sensor device |
| 32R | Support element |
| 32L | Support element |
| 33R | Actuator |
| 33L | Actuator |
| 34 | Sensor unit |
| 35 | Processor |
| 36 | Memory |
| 37 | Communication interface |
| α | Tilt angle |
| β | Inclination |
| Γ | Transverse position angle |
| Δh | Deflection difference |
| ΔhR | Distance difference |
| ΔhL | Distance difference |
| RR | Deflection |
| HL | Deflection |
| k₀ | Factor |
| k₁ | Factor |
| k₂ | Factor |
| k₃ | Factor |
| k₄ | Factor |
| FR | Driving direction |

1. A method for operating an attachment positioned on a pick-up device, height-adjustable by actuators, of a self-propelled combine harvester and which comprises a center segment and at least two side segments, each having at least one position-variable support element arranged on respective side segments and acted upon by a pressure-controlled support force, the method comprising:
receiving, by a control device, one or more signals generated by one or more distance sensors;
evaluating, by the control device, the one or more signals;
performing, by the control device based on the evaluation of the one or more signals, transverse control of one or both of the attachment or one or both of the side segments in multiple operating modes;
wherein a transverse position angle of the attachment is set by pivoting about a virtual pendulum axis of the pick-up device;
wherein, in a first operating mode, the control device:
receives, from one or more distance sensors positioned on an underside of the attachment and contacting ground, one or more signals indicative of a distance between the ground and the attachment; and
performs, based on the distance between the ground and the attachment determined from the one or more distance sensors, the transverse control of one or both of the attachment or the one or both of the side segments;
wherein, in a second operating mode in which only the support elements are in contact with the ground, the control device:
receives, from one or more sensor units assigned to the support elements, one or more signals indicative of the distance of one or both of the attachment or one or both of the side segments from the ground; and
performs, based on the distance between the ground and the attachment determined from the one or more sensor units, the transverse control of one or both of the attachment or one or both of the side segments.

2. The method of claim 1, wherein a vertical deflection of a respective support element is detected by the one or more sensor units.

3. The method of claim 2, wherein, in the second operating mode, the control device:
determines a vertical deflection difference of the vertical deflection between the support elements; and
controls the vertical deflection of one or both of the support elements depending on the deflection difference.

4. The method of claim 3, wherein the control device controls actuation of one or more pressure-controlled actuators assigned to the support elements until the deflection difference is reduced.

5. The method of claim 4, wherein a scaling factor is used in the determination of the deflection difference.

6. The method of claim 1, wherein the control device uses an angle of inclination of the pick-up device for height control of the attachment.

7. The method of claim 1, wherein the side segments are each pivotably connected by a frame joint to the center segment about a pivot axis oriented in a driving direction of the combine harvester;
wherein each of the two side segments are pivoted relative to the center segment about the pivot axis;
wherein the transverse control for each of the two side segments uses a respective actuator; and
wherein the control device independently controls the respective actuator for each of the two side segments for independently performing the transverse control.

8. The method of claim 7, wherein, in the second operating mode, the position of the respective side segment relative to the center segment is calculated depending on a distance difference between the respective side segment and the ground; and
wherein the distance difference is determined from measured variables independent of the one or more signals of the one or more distance sensors.

9. The method of claim 8, wherein, in the second operating mode, the control device performs the transverse control of the respective side segment depending on an inclination angle of the pick-up device, the transverse position angle of the center segment, an inclination of the respective side segment relative to the center segment as independent measured variables, and a deflection of the support element assigned to the respective side segment).

10. The method of claim 9, wherein at least one scaling factor is used for at least one of the independent measured variables when determining the distance difference.

11. The method of claim 1, wherein the one or more distance sensors comprises one or more pivotable sensing bands contacting the ground, an actual pivot position of which is detected by one or more sensors assigned thereto; and
wherein, in the second operating mode, the control device compares the actual pivot position that is detected with a stored threshold value.

12. The method of claim 11, wherein, in the second operating mode, the control device:
determines whether the one or more signals from the sensing bands are less than the threshold value; and
responsive to determining that the one or more signals from the sensing bands are less than the threshold value, performing, based on the one or more signals from the sensing bands, the transverse control of one or both of the attachment or the one or both of the side segments.

13. A self-propelled combine harvester comprising:
a height-adjustable pick-up device configured to attach to an attachment, wherein the attachment comprises a center segment and two side segments, wherein at least one position-adjustable support element acted upon by a pressure-controlled support force is arranged on each of the side segments; and
a control device configured to:
receive one or more signals generated by one or more distance sensors;
evaluate the one or more signals;
perform, based on the evaluation of the one or more signals, transverse control of one or both of the attachment or one or both of the side segments in multiple operating modes;
wherein a transverse position angle of the attachment is set by pivoting about a virtual pendulum axis of the pick-up device;
wherein, in a first operating mode, the control device is configured to:
receive, from one or more distance sensors positioned on an underside of the attachment and contacting ground, one or more signals indicative of a distance between the ground and the attachment; and
perform, based on the distance between the ground and the attachment determined from the one or more distance sensors, the transverse control of one or both of the attachment or the one or both of the side segments;
wherein, in a second operating mode in which only the support elements are in contact with the ground, the control device is configured to:
receive, from one or more sensor units assigned to the support elements, one or more signals indicative of the distance of one or both of the attachment or one or both of the side segments from the ground; and
perform, based on the distance between the ground and the attachment determined from the one or more sensor units, the transverse control of one or both of the attachment or one or both of the side segments.

14. The self-propelled combine harvester of claim 13, wherein the control device is configured, in the second operating mode, to:
determine a deflection difference between the support elements; and
control deflection of the support elements depending on the deflection difference.

15. The self-propelled combine harvester of claim 14, wherein the control device is configured, in the second operating mode, to control the deflection of the support elements so that the deflection difference is reduced.

16. The self-propelled combine harvester of claim 15, wherein the control device is configured, in the second operating mode, to control the deflection of the support elements so that the deflection difference is reduced to zero.

17. The self-propelled combine harvester of claim 13, wherein the side segments are each pivotably connected by a frame joint to the center segment about a pivot axis oriented in driving direction of the combine harvester;
wherein the control device is configured to perform the transverse control by controlling an actuator in order to pivot a respective side segment relative to the center segment about the pivot axis;
wherein the control device is configured to adjust the position of the respective side segment relative to the center segment in the second operating mode; and
wherein the control device, in the second operating mode, is configured to determine, independently of the one or more signals from the one or more distance sensors, a distance difference of the respective side segment to the ground.

18. The self-propelled combine harvester of claim 17, wherein the control device, in the second operating mode, is configured to perform the transverse control of the respective side segment depending on one or more of the angle of inclination of the pick-up device, a transverse position angle of the center segment, an inclination of the respective side segment relative to the center segment, or deflection of the respective support element assigned to the respective side segment.

19. The self-propelled combine harvester of claim 17, wherein the control device, in the second operating mode, is configured to perform the transverse control of the respective side segment independently of the one or more signals from the one or more distance sensors including: the angle of inclination of the pick-up device, a transverse position angle of the center segment, an inclination of the respective side segment relative to the center segment, and deflection of the respective support element assigned to the respective side segment.
